(19) United States
(12) Patent Application Publication
(10) Pub. No.: US 2008/0218488 A1
(43) Pub. Date: Sep. 11, 2008

(54) ACTIVE DRIVING TYPE VISUAL-TACTILE DISPLAY DEVICE

(75) Inventors: Yong Suk Yang, Daejeon (KR); Seong Hyun Kim, Daejeon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon (KR)

(21) Appl. No.: 11/875,445

(22) Filed: Oct. 19, 2007

(30) Foreign Application Priority Data
Nov. 30, 2006 (KR) 10-2006-120135
Jun. 13, 2007 (KR) 10-2007-057604

(51) Int. Cl. G06F 3/041

(52) U.S. Cl. 345/173

(57) ABSTRACT

Provided is an active driving type visual and tactile display device, in which a flat panel display device for visually displaying an image and a haptic part for generating a tactile sense using an electrostatic force are integrated to generate textures according to an electrostatic force based on an image signal. As a result, visual and tactile senses may be simultaneously recognized. Since the display device enables a user to simultaneously see an image through a visual sense and perceive various textures through a tactile sense, the performance of a device is significantly improved. Therefore, various textures according to an image signal can be precisely realized by the generation of an electrostatic force per unit cell.

### CROSS-REFERENCE TO RELATED APPLICATION

This application claims priority to and the benefit of Korean Patent Application No. 2006-120135, filed Nov. 30, 2006, and No. 2007-57604, filed Jun. 16, 2007, the disclosure of which is incorporated herein by reference in its entirety.

### BACKGROUND

1. Field of the Invention

The present invention relates to an active driving type visual and tactile display device, and more particularly, to a display device in which a flat panel display device for visually displaying an image and a haptic part for generating a tactile sense using electrostatic force are integrated.

This work was supported by the IT R&D program of Ministry of Information and Communication/Institute for Information Technology Advancement [2005-S-070-02, Flexible Display.]

2. Discussion of Related Art

Generally, a display is a device that digitizes sound and images of a phenomenon or an object to transmit information. Since humans have the five senses including the tactile, olfactory and gustatory senses besides the visual and auditory senses, demand for the transmission and exchange of information related to other senses is currently on the rise. Despite this, methods of quantifying and providing information on the tactile sense fall short of meeting the rising demand for such information. However, if quantification and rationalization of a tactile sense and analyses of the relationships between tactile sense and human perception are applied to industrial fields, production of high value-added communication media, which satisfies the needs of customers, may be possible.

Extensive research into a method of interchanging information between media and humans using the five senses has been done. For example, besides providing visual and auditory information, which is a basic function of information media, a method of providing tactile information through a method of moving chairs so that a user can tactilely sense vibration, e.g., while watching a movie, and a method of providing stimulation to the olfactory sense by spraying a scent have been disclosed. Among the above methods, coupling the tactile sense or tactile force to virtual environment data that a computer generates is referred to as haptics, which is derived from a Greek word “haptesthai (to touch)”. Actually, the tactile sense is very sensitive to force, vibration, temperature, etc., and because humans react faster to the tactile sense than to the visual sense or the auditory sense, the tactile sense does not easily lend itself to quantification and integration.

Conventionally, a mechanical simulator array has been used to simulate the surface texture of an object. For example, in order to stimulate mechanoreceptors in the skin, a DC motor, a piezoelectric device, a shape memory alloy actuator, an ultrasonic vibrator, an air jet, a pneumatic actuator, a Peltier device, a surface acoustic wave device, a device using acoustic radiation pressure, a pressure valve device, an ionic conducting polymer gel film, etc., can be used. Besides mechanical stimulators, there has also been extensive research into the use of electromagnetic force. For example, attraction, repulsion, and friction are generated from the use of an electrostatic force without applying mechanical pressure, an electromagnetic micro-coil, electrostimulation, direct current (DC), etc. to stimulate the skin.

The idea of producing artificial texture using electrostatic force has been studied for a long time since it can generate a tactile sense with a simple structure and, unlike current, it does not have a direct effect on humans. A detailed description thereof will be made below.

Basically, an electrostatic force Fₑ that operates between a circular electrode having an area A and an electrode having a larger area (e.g., a conductive thin film mounted on the skin of a finger to be contacted) may be calculated by the following Equation 1.

Fₑ=εₒεᵣAV²/(2d²) [Equation 1]
wherein εₒ represents a permittivity, εᵣ represents a dielectric constant between the two electrodes, d represents a distance between the two electrodes, and V represents a voltage applied between the two electrodes.

As confirmed by Equation 1, the electrostatic force Fₑ is proportional to the dielectric constant εᵣ, the area A of the electrode and the applied voltage V, and inversely proportional to the distance d between the two electrodes.

When a surface friction coefficient of the circular electrode becomes μ according to the electrostatic force between the two electrodes, a shear force Fₜ generated from the electrostatic force becomes μFₑ. Therefore, when the value and the polarity of a voltage applied to the circular electrode are controlled over time, various changes in shear force and the generation of tactile senses can be obtained.

By means of the principle of generating a tactile sense, a Braille display device, in which 7×7 electrode arrays are fabricated on a 4-inch Si wafer, and a voltage is applied in the form of a simple figure to produce a tactile sensation, has been disclosed.

However, in this display device, visual information simply expressed in Braille is sensed tactilely, and thus the display is not implemented to stimulate both the visual and tactile senses. Also, the wiring of each electrode is somewhat complicated, and the electrostatic force cannot be generated by each pixel due to insufficient resolution, so that texture of a material cannot be sufficiently produced.

### SUMMARY OF THE INVENTION

The present invention is directed to an active driving type visual and tactile display device, in which a flat panel display device for visually displaying an image and a haptic part for generating a tactile sense using an electrostatic force are integrated to generate textures according to an electrostatic force depending on an image signal, so that both visual and tactile senses may be simultaneously perceived.

The present invention is also directed to an active driving type visual and tactile display device capable of accurately implementing various textures depending on an image signal.

One aspect of the present invention provides an active driving type visual and tactile display device, in which a flat panel display device for visually displaying an image and a haptic part for generating a tactile sense using an electrostatic force are integrated. Each unit cell of the haptic part may comprise first to third transistors, a capacitor and a transparent electrode. Also, when a detector approaches the transparent electrode of the haptic part, an electrostatic force may be generated between the transparent electrode and the detector, and the detector may sense the electrostatic force to simultaneously recognize visual and tactile information.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings in which:

FIG. 1 schematically illustrates the configuration of an active driving type visual and tactile display device according to an exemplary embodiment of the present invention;

FIG. 2 illustrates the detailed configuration of a haptic part according to an exemplary embodiment of the present invention;

FIG. 3 is a plan view illustrating a unit pixel circuit and an interconnection of the haptic part of FIG. 2;

FIG. 4 illustrates the operation of the haptic part according to an exemplary embodiment of the present invention;

FIG. 5 illustrates a unit pixel circuit of the haptic part using an inverter according to an exemplary embodiment of the present invention; and

FIG. 6 illustrates the detailed configuration of a detector for detecting an electrostatic force generated from the haptic part according to an exemplary embodiment of the present invention.

### DETAILED DESCRIPTION OF EMBODIMENTS

The present invention will now be described more fully hereinafter with reference to the accompanying drawings, in which exemplary embodiments of the invention are shown. This invention may, however, be embodied in different forms and should not be construed as limited to the exemplary embodiments set forth herein.

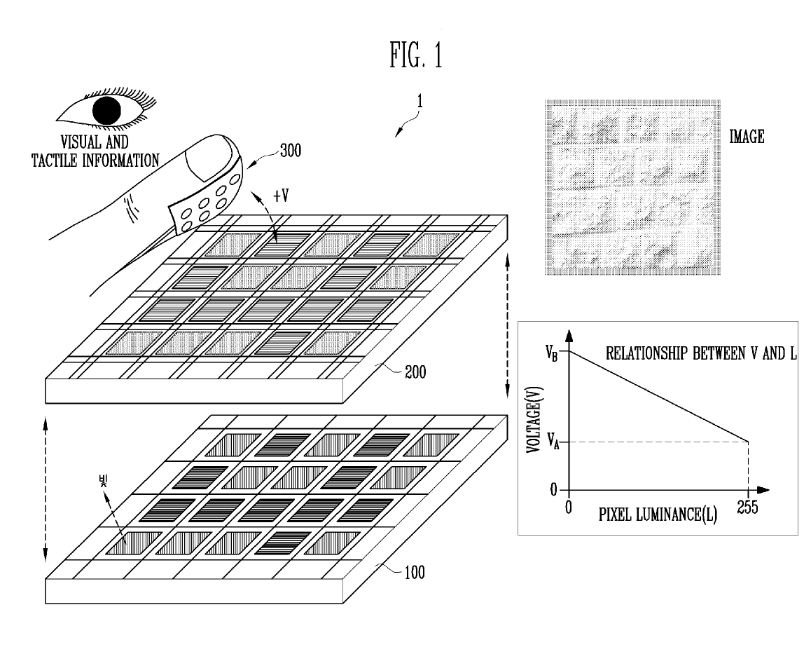

FIG. 1 schematically illustrates the configuration of an active driving type visual and tactile display device 1 according to an exemplary embodiment of the present invention.

As illustrated in FIG. 1, in the active driving type visual and tactile display device 1, a flat panel display device 100 visually displaying an image and a haptic part 200 generating an electrostatic force for delivering tactile information according to the image are integrated. Here, the flat panel display device 100 and the haptic part 200 may be manufactured on different substrates to be integrated, or the flat panel display device 100 may be manufactured on a substrate and haptic part 200 may be deposited thereon to be integrated.

That is, as illustrated in FIG. 1, when a wall image appearing to have bumps and creases in dark parts is input, a user can see the bumps and creases of the wall and simultaneously, can perceive the bumps and creases by a detector 300 attached to a finger.

In order to generate the tactile sense, the present invention uses the relationship between luminance L of a pixel and a constant-voltage V generating an electrostatic force. Accordingly, in the haptic part 200 and the detector 300 of the present invention, when pixel brightness is 225, which is the brightest brightness level, a threshold voltage V_{A} is applied so that a user can perceive a tactile sense, and when the brightness is 0, which is the darkest brightness level, a maximum voltage V_{B}, in which a user can perceive the maximum frictional force, is applied, so that tactile senses between the brightest part and the darkest part may be perceived differently. Here, the threshold voltage V_{A} may vary depending on thickness, materials, type, etc. of the detector 300 a user wears.

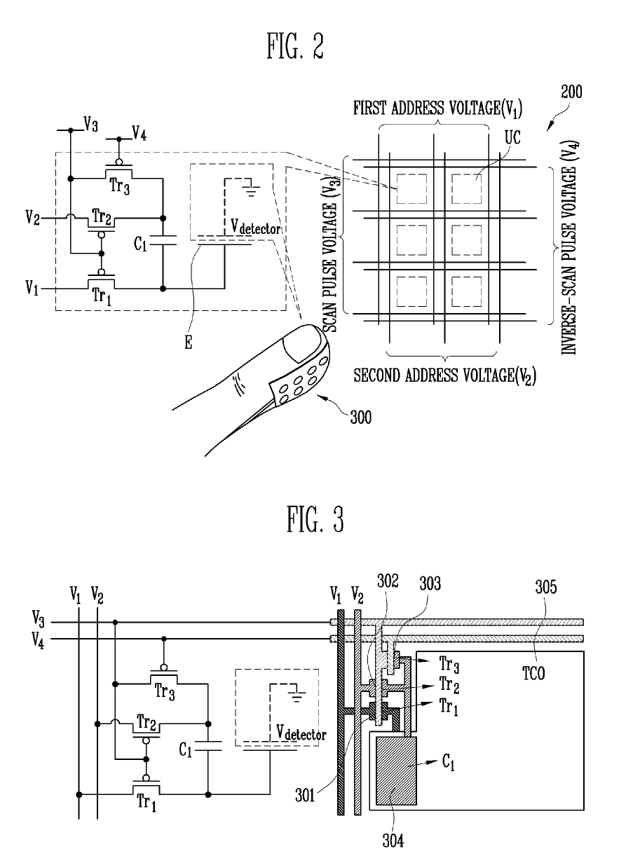

Meanwhile, to more precisely implement the visual and tactile senses, other means capable of implementing various textures are required besides the relationship between the luminance L and the voltage V generating an electrostatic force, and detailed descriptions thereof will be made below with reference to FIG. 2.

FIG. 2 illustrates the detailed configuration of the haptic part 200 according to an exemplary embodiment of the present invention.

As illustrated in FIG. 2, each unit cell (UC) of the haptic part 200 generates an electrostatic force using first to third transistors Tr₁, Tr₂ and Tr₃, a capacitor C₁ and a transparent electrode E. Then, the electrostatic force generated in each unit cell UC is sensed by a detector 300 attached to a finger, so that a tactile sense can be perceived.

Particularly, in order for the tactile display device to deliver visual information, which is impossible in the conventional art, the transparent electrode E is formed of a transparent conductive oxide thin film in the haptic part 200 of the present invention, so that both visual information and tactile information can be delivered. Detailed descriptions of connection to each component will be briefly made below.

A scan pulse voltage V₃ is applied to gates of the first and second transistors Tr₁ and Tr₂, a first address voltage V₁ and a second address voltage V₂ are respectively applied to sources of the transistors. Drains of the first and second transistors Tr1 and Tr2 are connected to the capacitor C₁ and a drain of the third transistor Tr₃. An inverse-scan pulse voltage V₄ whose polarity is opposite to the scan pulse voltage V₃ is applied to a gate of the third transistor Tr₃, the scan pulse voltage V₃ is applied to a source of the third transistor Tr3, and the capacitor C₁ is connected between the drains of the first and second transistors Tr₁ and Tr₂.

The process of generating a tactile sense by the haptic part 200 is largely divided into three processes.

The processes include a writing process of applying a voltage to both ends of the capacitor C₁ using the transistors Tr₁, Tr₂ and Tr₃ to produce a potential difference, a sustaining process in which the charged voltage is maintained until the next writing process, and a detecting process in which the detector 300 approaches the transparent electrode E to generate an electrostatic force between the haptic part 200 and the detector 300.

First, in the writing process, a scan pulse voltage V₃ is applied to the gates of the first and second transistors Tr₁ and Tr₂ to turn them on. Simultaneously, a first address voltage V₁ and a second address voltage V₂ are respectively applied to the sources of the first and second transistors Tr₁ and Tr₂ to generate a potential difference of |V₁-V₂| at both ends of the capacitor C₁. The potential difference generated at both ends of the capacitor C₁ will be used as a drive voltage that drives the haptic part 200.

In the sustaining process, in which the charged voltage is maintained, the scan pulse voltage V₃ is grounded, which is in the state of a zero potential difference, and the first and second transistors Tr₁ and Tr₂ are turned off. Here, the inverse-scan pulse voltage V₄ is an opposite signal to the scan pulse voltage V₃. That is, when the scan pulse voltage V₃ becomes the same voltage level as the voltage V, the inverse-scan pulse voltage V₄ is grounded, and when the scan pulse voltage V₃ is grounded, the inverse-scan pulse voltage V₄ becomes the same voltage level as the voltage V.

In other words, in the writing process, the first and second transistors Tr₁ and Tr₂ are turned on, but the third transistor Tr₃ is turned off. In the sustaining process, the first and second transistors Tr₁ and Tr₂ are turned off, but the third transistor Tr₃ is turned on.

In the detecting process, the detector 300 approaches the transparent electrode E to form a closed circuit between the transparent electrode E and the detector 300, so that an electrostatic force is generated while the third transistor Tr₃ is turned on. Here, a potential difference between the transparent electrode E and the detector 300 is the same as the potential difference |V₁-V₂| generated in the capacitor C₁.

Further, while the electrostatic force is generated as described above, when the detector 300 moves on each unit cell UC, a shear force μFₑ equivalent to the multiplication of an electrostatic force Fₑ and a surface friction coefficient μ is generated. Further, the value and the polarity of a voltage of each corresponding unit cell may be adjusted over time. Accordingly, various changes in shear force and various textures may be obtained.

FIG. 3 is a plan view illustrating a unit cell and an interconnection of the haptic part 200 illustrated in FIG. 2.

Referring to FIG. 3, the unit cell UC of the haptic part 200 includes a first transistor Tr₁ region, to which a first address voltage V₁ is applied through an interconnection circuit 301, a second transistor Tr₂ region, to which a second address voltage V₂ is applied through an interconnection circuit 302, a third transistor Tr₃ region, to which an inverse-scan pulse voltage V₄ is applied through an interconnection circuit 303, a capacitor region 304, and a transparent electrode region 305.

Here, regions where the interconnection circuits 301, 302 and 303 overlap are isolated by an insulating layer, gate insulating layers and semiconductor layers disposed on the first to third transistors Tr₁, Tr₂ and Tr₃, and a dielectric layer disposed on a capacitor C₁ are omitted for simplicity.

Particularly, in the unit cell UC of the haptic part 200 of the present invention, the transparent electrode region 305 may be designed as large as possible. This is because a large electrostatic force may be obtained when the region is in contact with the detector 300.

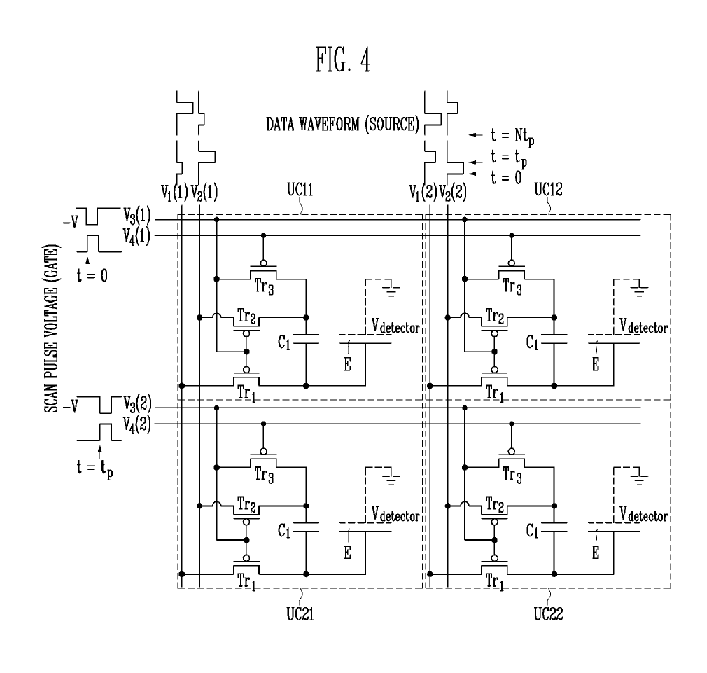

FIG. 4 illustrates the operation of the haptic part 200 according to an exemplary embodiment of the present invention. Each unit cell includes three p-type transistors Tr₁, Tr₂ and Tr₃, a capacitor C₁ and a transparent electrode E. An amorphous silicon transistor or an organic pentacene transistor may be used as the p-type transistor.

Referring to FIG. 4, first, in order to operate a unit cell UC11 at an intersection of a first column and a first row, a voltage −V is applied to a first scan pulse voltage V₃(1) and a zero (0) voltage is applied to an inverse-scan pulse voltage V₄(1) during a time period of 0 to tₚ, so that the first and second transistors Tr₁ and Tr₂ are turned on, and the third transistor Tr₃ is turned off.

Simultaneously, a voltage −Vᵢ is applied to a first address voltage V₁(1), and a zero (0) voltage is applied to a second address voltage V₂(1), SO that a potential difference of Vᵢ is generated at both ends of the capacitor C₁ during a writing process, and an electrode connected to the transparent electrode E is charged with a negative voltage.

At the same time, a writing process of a unit cell UC12 at an intersection of the first row and a second column is performed. That is, a zero voltage and a voltage −Vⱼ are respectively applied to another first address voltage V₁(2) and another second address voltage V₂(2) to charge the capacitor C₁, so that an electrode connected to the transparent electrode E is charged with a positive voltage.

Further, during a time period of tₚ to 2 tₚ, in order to operate a unit cell UC21 at an intersection of a second row and the first column and a unit cell UC22 at an intersection of the second column and the second row, a voltage −V is applied to a second scan pulse voltage V₃(2) and a zero voltage is applied to a second inverse-scan pulse voltage V₄(2). As a result, the first and second transistors Tr₁ and Tr₂ are turned on and the third transistor Tr₃ is turned off.

Then, voltages of 0V, −Vₖ, −V₁, 0V are respectively applied to the first address voltage V₁(1), the second address voltage V₂(1), another first address voltage V₁(2) and another second address voltage V₂(2) to charge the capacitors C₁ in the unit cells UC21 and UC22.

During these processes, the first and second transistors Tr₁ and Tr₂ in the unit cells UC11 and UC12 are turned off, and the third transistor Tr₃ is turned on, so that one side of the capacitor C₁ is connected to the ground and the other side is connected to the transparent electrode E.

Then, when the detector 300 approaches the transparent electrode E, a closed circuit is formed between the capacitor C₁, the transparent electrode E and the detector 300, so that both ends of the transparent electrode E and the detector 300 are charged and an electrostatic force is generated at the both ends.

That is, given that the number of rows is N, a scan pulse voltage is sequentially applied to every unit cell from the first to Nth rows during a time period of 0 to Ntₚ.

Then, the process returns to Ntₚ to repeatedly operate, and in this case, data waveforms of the first and second address voltages V₁(m) and V₂(m) at each intersection are designed such that address voltages applied to each unit cell have opposite polarity. This is because the polarities of the transparent electrode in each frame are changed to lead vibration to an electrostatic force and to easily control the strength and weakness of a frictional force.

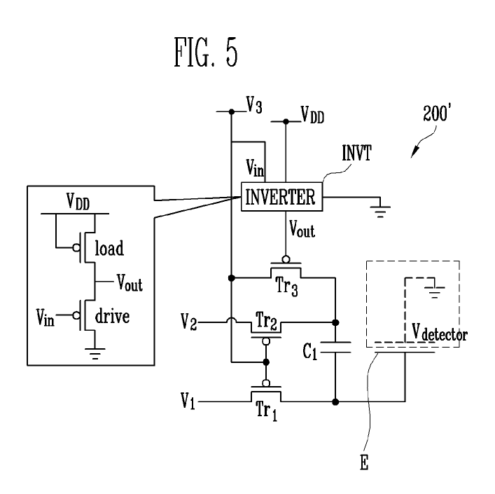

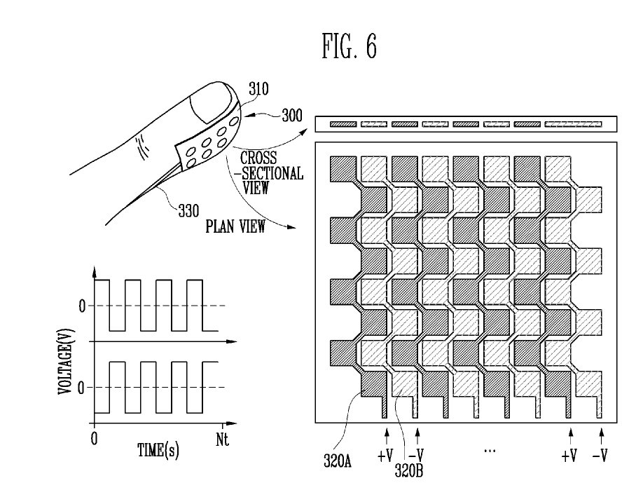

FIG. 5 illustrates a circuit diagram of a unit cell of a haptic part 200′ according to an exemplary embodiment of the present invention.

As illustrated in FIG. 5, when an inverter INVT is used, any interconnection for applying the inverse-scan pulse voltage V₁ illustrated in FIG. 2 is not required.

The inverter INVT is an e-type inverter including p-type transistors, a scan pulse voltage V₃ is used as an input voltage Vᵢₙ, and an output voltage Vₒᵤₜ, is applied to a gate of a third transistor Tr₃. As a result, a gate voltage signal of the third transistor Tr₃ becomes opposite to the scan pulse voltage V₃, so that it functions exactly the same as the scan pulse voltage V₄ of FIG. 2.

FIG. 6 illustrates the detailed configuration of the detector 300 for detecting an electrostatic force generated from the haptic part 200 according to an exemplary embodiment of the present invention.

As illustrated in FIG. 6, the detector 300 can be mounted on a finger and includes a pad portion 310 including an electrode array and a connection portion 330.

The pad portion 310 includes two types of electrodes 320A and 320B that are arranged in a zigzag, and the electrodes 320A and 320B may be coated with an insulating material for safety.

Further, voltages +V and −V having temporally opposite polarities are applied to the electrodes 320A and 320B as illustrated in FIG. 6. Accordingly, the polarities of electrodes that are temporally and spatially adjacent to each other become opposite.

The reason why the voltages +V and −V are applied to the electrodes 320A and 320B of the pad portion 310 is to apply a voltage waveform similar to a voltage applied to a haptic part 200, so that a voltage increase of the haptic part 200 with respect to the threshold voltage V_{A} described in FIG. 1 is compensated, and an electrostatic force between the electrodes and the transparent electrode E is increased.

As described above, the active driving type visual and tactile display device 1, in which the flat panel display device 100 visually displaying an image and the haptic part 200 generating a tactile sense using an electrostatic force are integrated, is provided. In the display device, a user can simultaneously see an image and perceive various textures through the detector 300 attached to a finger.

As described above, an active driving type visual and tactile display device of the present invention enables a user to perceive textures through an electrostatic force according to an image signal. Therefore, a user can see an image and perceive various textures, so that the performance of a display device is considerably improved.

Further, the active driving type visual and tactile display device of the present invention generates an electrostatic force per unit cell, so that various textures can be implemented according to an image signal.

Exemplary embodiments of the invention are shown in the drawings and described above in specific terms. However, no part of the above disclosure is intended to limit the scope of the overall invention. It will be understood by those of ordinary skill in the art that various changes in form and details may be made to the exemplary embodiments without departing from the spirit and scope of the present invention as defined by the following claims.

What is claimed is:

1. An active driving type visual and tactile display device comprising:
a flat panel display device for visually displaying an image and a haptic part for generating a tactile sense using an electrostatic force, which are integrated, the haptic part comprising unit cells, each of which comprises first to third transistors, a capacitor, and a transparent electrode; and
a detector for generating an electrostatic force between the transparent electrode and the detector when it approaches the transparent electrode of the haptic part, so that the detector senses the electrostatic force to simultaneously recognize visual and tactile information.

2. The device of claim 1, wherein the detector is mountable on a finger.

3. The device of claim 1, wherein the transparent electrode is formed of a transparent conductive oxide thin film.

4. The device of claim 3, wherein the capacitor is connected between drains of the first and second transistors.

5. The device of claim 1, wherein scan pulse voltages are applied to gates of the first and second transistors, first and second address voltages are respectively applied to sources of the first and second transistors, and the capacitor and a drain of the third transistor are connected to drains of the first and second transistors.

6. The device of claim 5, wherein the scan pulse voltages are applied to the gates of the first and second transistors and the first and second address voltages are respectively applied to the sources of the first and second transistors, so that a driving voltage that drives the haptic part is generated at both ends of the capacitor.

7. The device of claim 5, wherein an inverse-scan pulse voltage that is opposite to the scan pulse voltage is applied to a gate of the third transistor and the scan pulse voltage is applied to a source of the third transistor.

8. The device of claim 6, wherein when the scan pulse voltage is connected to the ground, the first and second transistors are turned off, and when the inverse-scan pulse voltage is applied to the third transistor, the third transistor is turned on, so that the driving voltage at both ends of the capacitor is maintained.

9. The device of claim 8, wherein when the detector approaches the transparent electrode while the third transistor is turned on, an electrostatic force is generated between the transparent electrode and the detector.

10. The device of claim 9, wherein when the detector moves on the unit cell of the haptic part, a shear force is generated by the generated electrostatic force and surface frictional force to recognize a tactile sense.

11. The device of claim 5, wherein the shear force is changed depending on the values and polarities of the scan pulse voltage, the inverse-scan pulse voltage, the first address voltage and the second address voltage applied to each unit cell of the haptic part.

12. The device of claim 10, wherein the shear force is changed depending on the values and polarities of the scan pulse voltage, the inverse-scan pulse voltage, the first address voltage and the second address voltage applied to each unit cell of the haptic part.

13. The device of claim 10, wherein different polarity voltages are applied to the unit cells that are spatially adjacent to each other in the haptic part, so that a shear force and vibration are simultaneously generated by the generated electrostatic force and surface frictional force.

14. The device of claim 1, wherein the detector comprises a pad portion having an electrode array and a connection portion, wherein the pad portion comprises different types of electrodes, which are arranged in a zigzag, and different polarity voltages are applied to the different types of electrodes.

15. The device of claim 13, wherein the different polarity voltages are applied to the different types of electrodes, so that the electrostatic force generated at both ends of the transparent and the detector is increased.

16. The device of claim 13, wherein the pad portion is coated with an insulating material.

17. The device of claim 1, wherein each unit cell of the haptic part further comprises an inverter formed of a p-type or n-type transistor, wherein the inverter inverses the polarity by receiving the scan pulse voltage to apply the voltage to the gate of the third transistor.

18. The device of claim 5, wherein each unit cell of the haptic part further comprises an inverter formed of a p-type or n-type transistor, wherein the inverter inverses the polarity by receiving the scan pulse voltage to apply the voltage to the gate of the third transistor.

19. The device of claim 1, wherein the first to third transistors are formed of p-type transistors.
